(19) United States
(12) Patent Application Publication
(10) Pub. No.: US 2016/0112078 A1
(43) Pub. Date: Apr. 21, 2016

(54) TERMINAL AND POWER CHARCHING METHOD THEREOF

(71) Applicant: Electronics and Telecommunications Research Institute, Daejeon (KR)

(72) Inventors: Hyung Sik JU, Daejeon (KR); Kapseok CHANG, Daejeon (KR); Seon-Ae KIM, Daejeon (KR)

(21) Appl. No.: 14/885,798

(22) Filed: Oct. 16, 2015

(30) Foreign Application Priority Data
Oct. 17, 2014 (KR) 10-2014-0140916
Oct. 14, 2015 (KR) 10-2015-0143553

(51) Int. Cl. H04B 1/10; H04B 1/18; H02J 7/02; H04B 1/525

(52) U.S. Cl. CPC H04B 1/10; H04B 1/525; H04B 1/18; H02J 7/025

(57) ABSTRACT

Disclosed herein are a terminal and a power charging method thereof. The terminal may include: an information transmitter generating a first signal corresponding to an uplink signal transmitted to a base station; and a power harvester receiving a self-interference signal generated by the first signal and charging power using the self-interference signal.

### CROSS-REFERENCE TO RELATED APPLICATION

This application claims priority to and the benefit of Korean Patent Application Nos. 10-2014-0140916 and 10-2015-0143553, filed in the Korean Intellectual Property Office on Oct. 17, 2014 and Oct. 14, 2015, respectively, the entire contents of which are incorporated herein by reference.

### BACKGROUND OF THE INVENTION

(a) Field of the Invention

The present invention relates to a terminal and a power charging method thereof.

(b) Description of the Related Art

To solve a battery consumption problem of a terminal in a wireless communication system, various energy harvesting and wireless power transmission schemes have been developed. Among the various schemes, there is a wireless power transmission technology using a radio frequency (RF). For the power transmission using the RF, a rectifier antenna in which a diode and a low pass filter are connected to an antenna is used. The rectifier antenna converts the received RF energy into electrical energy, and is known to have energy conversion efficiency of about 70 to 80%. The wireless power transmission technology using the RF has advantages of making long-distance power transmission and multicasting easier and being appropriate for mobility of a terminal, compared to other wireless power transmission schemes. However, the wireless power transmission technology using the RF may have disadvantages in that power transmission efficiency may be reduced due to attenuation of an RF signal, an effect of a radio channel, etc., depending on a distance.

In the existing wireless power transmission technology using the RF, a base station having a stable power supply source transmits power to the terminal through a downlink and the terminal uses the received power to transmit radio information through an uplink. In this case, the downlink for the wireless power transmission and the uplink for wireless information transmission are differentiated from each other by a half duplex (HD) scheme. However, the half duplex scheme causes a waste of time or frequency resources to reduce the power transmission efficiency and the information transmission efficiency.

Meanwhile, an in-band full duplex (IFD) scheme simultaneously transmits/receives a wireless signal in an in-band, thereby theoretically improving link capacity to double. However, in the in-band full duplex (IFD) scheme, the transmitted signal acts as strong interference against a valid received signal. That is, the transmitted signal transmitted from a transmitter is introduced into a receiver in a self-interference (SI) form. A technology (self-interference cancellation) of removing the self-interference is very complicated and is difficult to implement. In particular, in a wideband system it is difficult to express all characteristics for each frequency and it is sensitive to the surrounding environment (multi-path fading environment) and mobility of the terminal. Further, the in-band full duplex scheme causes a very large quantization error when analog-to-digital converter (ADC) is performed by automatic gain control (AGC), compared to the half duplex scheme. In the in-band full duplex scheme, a lot larger self-transmission interference signal than a self-received signal is introduced into the received signal introduced into a receiving terminal, such that the AGC and the ADC are performed on a sum of the self-received signal and the self-transmission interference. As a result, the in-band full duplex scheme may have a very high quantization error and therefore it is difficult to apply a high-dimensional modulation scheme (for example, quadrature amplitude modulation (M-QAM)). Further, power consumption for SIC may also be greatly increased.

### SUMMARY OF THE INVENTION

The present invention has been made in an effort to provide a terminal using a self-interference signal for power charging and a power charging method thereof.

An exemplary embodiment of the present invention provides a terminal. The terminal may include: an information transmitter generating a first signal corresponding to an uplink signal transmitted to a base station; and a power harvester receiving a self-interference signal generated by the first signal and charging power using the self-interference signal.

The terminal may further include: a first band pass filter passing through a band corresponding to the uplink signal; a second band pass filter passing through a band corresponding to a downlink signal received from the base station; a distributor transmitting the first signal to the first band pass filter and transmitting the self-interference signal to the power harvester; and an information receiver decoding a signal passing through the second band pass filter.

The terminal may further include: an information receiver decoding a downlink signal received from the base station; a distributor transmitting the first signal through an antenna and transmitting the self-interference signal to the power harvester; and a switch switching between the antenna and the distributor or between the antenna and the information receiver.

The terminal may be operated in a time division half duplex scheme, when the terminal is in a transmitting mode, the switch may connect between the antenna and the distributor, and when the terminal is in a receiving mode, the switch may connect the antenna and the information receiver.

The terminal may further include: an information receiver decoding a downlink signal received from the base station; a distributor transmitting the first signal through an antenna and transmitting the self-interference signal to the power harvester; and a first switch switching between the distributor and the power harvester or between the distributor and the information receiver.

When the terminal is operated in an in-band full duplex scheme, the first switch may connect between the distributor and the information receiver, and when the terminal is operated in a time division half duplex scheme and is in a transmitting mode, the first switch may connect between the distributor and the power harvester and the self-interference signal may be input to the power harvester through the distributor.

When the terminal is operated in the time division half duplex scheme and is in a receiving mode, the first switch may connect between the distributor and the receiver.

When the terminal is within a first distance from the base station, the terminal may be operated in the in-band full duplex scheme, and when the terminal is at a second distance farther than the first distance from the base station, the terminal may be operated in the time division half duplex scheme.

The power harvester may include: a battery unit storing power; and an energy harvester converting the self-interference signal into a form chargeable in the battery unit and outputting the converted self-interference signal to the battery unit.

The energy harvester may include: a diode rectifying the self-interference signal; and a low pass filter passing through only a low frequency signal in the diode output.

The power harvester may charge power using a power signal transmitted from the base station.

Another embodiment of the present invention provides a method for charging power by a terminal transmitting an uplink signal to a base station and receiving a downlink signal from the base station. The method may include: generating a first signal corresponding to the uplink signal; extracting a self-interference signal from the first signal; and charging power using the self-interference signal.

The method may further include: determining whether the terminal is within a predetermined distance from the base station, and when the terminal is within the predetermined distance, the terminal may be operated in an in-band full duplex scheme, while when the terminal is not within the predetermined distance, the terminal may be operated in a time division half duplex scheme.

Yet another exemplary embodiment of the present invention provides a terminal. The terminal may include: an information transmitter generating a first signal corresponding to an uplink signal transmitted to a base station; an information receiver decoding a downlink signal received from the base station; a power harvester charging power using a self-interference signal generated by the first signal; and a switch switching between the antenna and the power harvester or between the antenna and the information receiver depending on a mode.

The mode may include a transmitting mode and a receiving mode, and when the terminal is operated in a time division half duplex scheme and is in a transmitting mode, the first switch may connect between the antenna and the power harvester and the self-interference signal may be input to the power harvester.

The terminal may further include: a distributor positioned between the antenna and the switch and positioned between the antenna and the information transmitter, in which the self-interference signal may be input to the power harvester through the distributor and the switch.

When the terminal is within a first distance from the base station, the terminal may be operated in the in-band full duplex scheme, and when the terminal is at a second distance farther than the first distance from the base station, the terminal may be operated in the time division half duplex scheme.

According to an exemplary embodiment of the present invention, it is possible to increase the energy use efficiency by using the self-interference signal for power charging.

Further, according to another exemplary embodiment of the present invention, it is possible to implement various transmission schemes by manipulation of switches and use the self-interference signal for power charging.

### BRIEF DESCRIPTION OF THE DRAWINGS

FIG. 1 is a diagram illustrating a wireless communication system according to an exemplary embodiment of the present invention.

FIG. 2 is a block diagram illustrating a terminal according to an exemplary embodiment of the present invention.

FIG. 3 is a diagram illustrating an energy harvester according to an exemplary embodiment of the present invention.

FIG. 4 is a diagram illustrating a terminal according to an exemplary embodiment of the present invention.

FIG. 5 is a diagram illustrating a terminal according to a second exemplary embodiment of the present invention.

FIG. 6 is a diagram illustrating a terminal according to a third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like, and may include functions of all or some of the MT, the AMS, the HR-MS, the SS, the PSS, the AT, the UE, and the like.

Further, a base station (BS) may be called an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like, and may also include functions of all or some of the ABS, the nodeB, the eNodeB, the AP, the RAS, the BTS, the MMR-BS, the RS, the HR-RS, and the like.

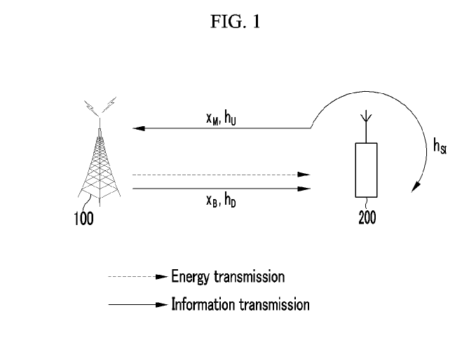

FIG. 1 is a diagram illustrating a wireless communication system according to an exemplary embodiment of the present invention.

As shown in FIG. 1, a wireless communication system according to an exemplary embodiment of the present invention includes a base station 100 and a terminal 200. FIG. 1 illustrates that there are one base station 100 and one terminal 200, but there may be multiple base stations 100 and terminals 200.

In the wireless communication system according to the exemplary embodiment of the present invention, power (energy) transmission and information transmission are performed in an in-band. That is, the base station 100 and the terminal 200 all both operated in a full duplex scheme.

The base station 100 transmits a signal to the terminal through a downlink. In this case, the signal included in the downlink may include data (corresponding to the information transmission of FIG. 1) and power (corresponding to energy transmission of FIG. 1).

Further, the terminal 200 demodulates data when the signal transmitted from the base station 100 includes valid data (information transmission). The terminal 200 harvests energy when the signal transmitted from the base station 100 does not include the valid data (in the case of the energy transmission), and uses the harvested energy as power required for its own function maintenance and uplink information transmission.

In FIG. 1, x_{B} is a transmitting signal of the base station 100 and x_{M} is a transmitting signal of the terminal 200. h_{D} is a channel through which x_{B} passes in the downlink, h_{U} is a channel through which x_{M} passes in an uplink, and h_{SI} is a self-interference (SI) channel through which x_{M} passes. The terminal 200 is operated in an in-band full duplex scheme, and therefore the signal transmitted by the terminal 200 acts as the interference, which is called self-interference (SI). The channel for the self-interference SI is represented by h_{SI}.

The base station 100 performs an SIC to demodulate the signal transmitted from the terminal. The terminal 200 performs the SIC when demodulating the signal transmitted from the base station 100, but does not demodulate the signal and may not perform the SIC when harvesting the energy.

Meanwhile, the wireless communication system of FIG. 1 may be extended to a multi-user environment by time division multiple access (TDMA), etc.

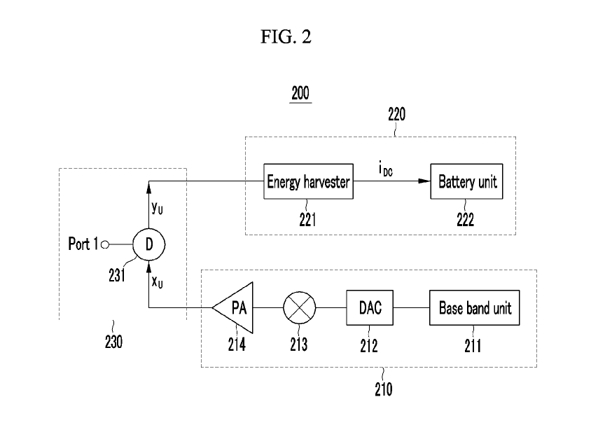

FIG. 2 is a block diagram illustrating a terminal according to an exemplary embodiment of the present invention. According to an exemplary embodiment of the present invention, the terminal 200 uses the self-interference (SI) signal to charge a battery.

As illustrated in FIG. 2, the terminal 200 according to the exemplary embodiment of the present invention includes an information transmitter 210, a power harvester 220, and a full duplex transmitter/receiver 230.

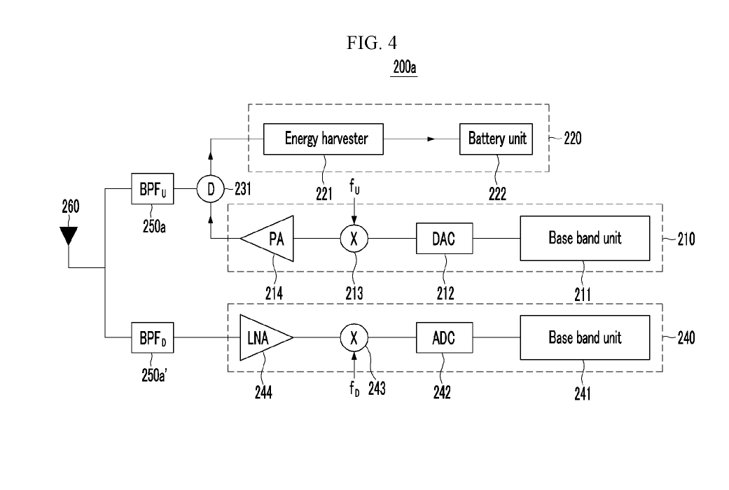

The full duplex transmitter/receiver 230 includes a distributor 231 and a port Port 1 so that the terminal 200 may perform the full duplex transmitter/receiver operation. The distributor 231 transmits a transmitting signal xᵤ of the information transmitter 210 to the port Port 1, and transmits the signal received through the port Port 1 to the information receiver (not illustrated). Further, the distributor 231 according to the exemplary embodiment of the present invention also outputs the signal received through the port Port 1 to the power harvester 200. The distributor 231 may be implemented as a circulator, an electrical balance duplexer (EBD), etc. Meanwhile, the port Port 1 may be one of several ports of the distributor 231. As illustrated in FIGS. 4 to 6, a band pass filer (BPF), a switch, or an antenna may be connected to the port Port 1. A detailed configuration and an operation of the distributor 231 may be appreciated by a person having ordinary skill in the art to which the present invention pertains, and therefore the detailed description thereof will be omitted.

The power harvester 200 includes an energy harvester 221 and a battery unit 222. The energy harvester 221 serves to convert an output signal yᵤ of the full duplex transmitter/receiver 230 into a chargeable form of the battery unit 222. The radio frequency (RF) signal received from the base station 100 is converted into an electrical signal in an AC form by the antenna (not illustrated), and the signal in the AC form is introduced into the port Port 1 of the full duplex transmitter/receiver 230. Further, a portion of the transmitting signal xᵤ of the information transmitter 210 is again introduced into the port Port 1 in the self-interference (SI) signal form, and the introduced signal is also an electrical signal in the AC form. Hereinafter, the self-interference signal (SI) generated by the transmitting signal of the information transmitter 210 is mixed with a leakage signal of the distributor 231. Meanwhile, the distributor 231 outputs the electrical signal in the AC form to the energy harvester 221, and in FIG. 2, the electrical signal in the AC form is represented by yᵤ.

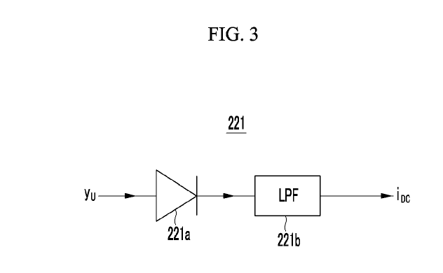

FIG. 3 is a diagram illustrating an energy harvester 221 according to an exemplary embodiment of the present invention.

As illustrated in FIG. 3, the energy harvester 221 according to the exemplary embodiment of the present invention includes a Schottky diode 221a and a low pass filter 221b. A configuration of the energy harvester 221 as illustrated in FIG. 3 has a rectifier structure and converts an AC current of the yᵤ into a DC current i_{DC}. The detailed operation of the energy harvester 221 may be appreciated by a person having ordinary skill in the art to which the present invention pertains, and therefore the detailed description thereof will be omitted.

The DC current i_{DC} generated by the energy harvester 221 is input to the battery unit 222 and the battery unit 222 uses the DC current i_{DC} to charge the battery. The detailed operation and operation of the battery unit 222 may be appreciated by a person having ordinary skill in the art to which the present invention pertains, and therefore the detailed description thereof will be omitted.

Meanwhile, the information transmitter 210 generates the signal xᵤ transmitted from the terminal 200 to the base station 100. The signal xᵤ generated by the information transmitter 210 corresponds to x_{M} of FIG. 1.

As illustrated in FIG. 2, the information transmitter 210 includes a baseband unit 211, a digital-analog converter 212, a mixer 213, and a power amplifier 214.

The baseband unit 211 generates a baseband signal which is a digital signal and the digital-analog converter 212 converts the digital signal into an analog signal. Further, the mixer 213 multiplies a carrier frequency by an analog signal, and the power amplifier 214 amplifies the transmitted signal and transmits the amplified transmitted signal to the full duplex transmitter/receiver 230.

An energy amount harvested by the terminal 200 as illustrated in FIG. 2 is mathematically expressed by the following Equation 1.

E_{M}=ζ_{M}∥y_{U}∥²T≈ζ_{M}∥δh_{D}x_{B}+α_{M}x_{M}∥²T (Equation 1)

In the above Equation 1, E_{M} is the energy amount harvested by the terminal 200 and ζ_{M} represents energy harvesting efficiency. T represents the received time of yᵤ. Further, α_{M} is a ratio of energy input to the power harvester 220 through the distributor 231 among the energy of the transmitting signal x_{M} or x_{U}. That is, α_{M} represents a ratio of the leakage signal (self-interference signal) energy of the information transmitter 210. Meanwhile, when the terminal 200 receives the power harvesting signal from the base station 100, δ=1 and otherwise δ=0.

As such, the terminal 200 according to the exemplary embodiment of the present invention uses the self-interference signal amount that is larger than the valid received signal for power harvesting, thereby increasing the energy use efficiency of the terminal.

In charging the battery with the self-interference signal (i.e., leakage signal) by the terminal 200 of FIG. 2, the structure and operation thereof may be changed depending on the transmitting/receiving scheme of the terminal 200. Hereinafter, various structures of the terminal 200 will be described with reference to FIGS. 4 to 6.

FIG. 4 is a diagram illustrating a terminal 200a according to a first exemplary embodiment of the present invention. The terminal 200a according to the first exemplary embodiment of the present invention is operated in a frequency division half duplex (FDD), and uses the self-interference (SI) signal generated in the frequency division half duplex scheme to charge the battery.

As shown in FIG. 4, the terminal 200a according to the first exemplary embodiment of the present invention includes the information transmitter 210, the power harvester 220, the distributor 231, an information receiver 240, a first band pass filter 250a, a second band pass filter 250a′, and an antenna 260. The terminal 200a of FIG. 4 is similar to the terminal of FIG. 3, except that the information receiver 240 and the two band pass filters 250a and 250a′ are added and therefore the overlapping description thereof will be omitted.

In FIG. 4, f_{D} represents a central carrier frequency of the downlink, and fᵤ represents a central carrier frequency of the uplink. In the frequency division half duplex scheme, a band allocated to the uplink and a band allocated to the downlink are different. Therefore, the terminal 200a passes only the uplink band through the first band pass filter 250a and passes only the downlink band through the second band pass filter 250a′. Meanwhile, the first band pass filter 250a is positioned between the antenna 260 and the distributor 231. That is, the first band pass filter 250a is connected to the port (Port 1 of FIG. 1) of the distributor 231. Further, the second band pass filter 250a′ is positioned between the antenna 260 and the information receiver 240.

The information receiver 240 has a structure of a general receiving terminal, and includes a low noise amplifier 244, a mixer 243, an analog-digital converter 242, and a baseband unit 241.

The transmitted signal output from the information transmitter 210 is transmitted through the distributor 231 and the first band pass filter 250a. The transmitted signal generates the self-interference signal (i.e., leakage signal), and the self-interference signal is input to the power harvester 200 through the distributor 231. The power harvester 220 converts the self-interference signal into the chargeable form to charge the battery. Meanwhile, the downlink signal (data signal transmitted from the base station 100) passes through the second band pass filter 250a′ to be input to the information receiver 240. The second band pass filter 250a′ is operated in the downlink band, and the transmitted signal of the information transmitter 210 is prevented from being fed-back to the information receiver 240.

The terminal 200a according to the first exemplary embodiment of the present invention may prevent the received signal of the downlink band which needs to be decoded in the information receiving terminal 240 from being used for the energy harvesting while simultaneously using the self-interference signal for energy harvesting.

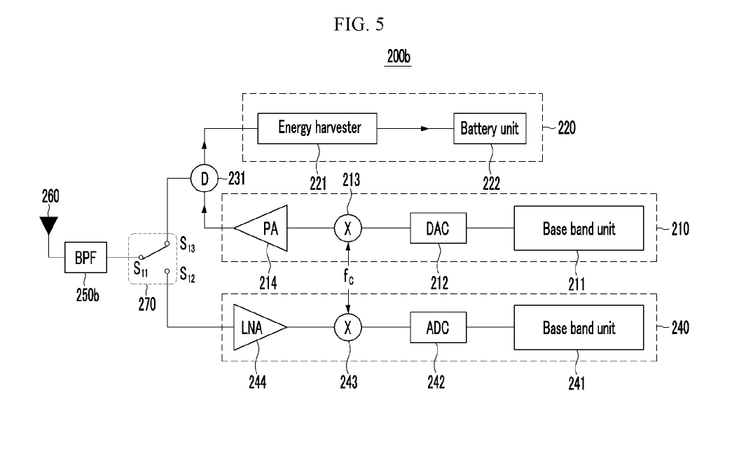

FIG. 5 is a diagram illustrating a terminal 200b according to a second exemplary embodiment of the present invention. The terminal 200b according to the second exemplary embodiment of the present invention is operated in a time division half duplex (TDD), and uses the self-interference (SI) signal generated in the time division half duplex scheme to charge the battery.

As illustrated in FIG. 5, the terminal 200b according to the second exemplary embodiment of the present invention includes the information transmitter 210, the power harvester 220, the distributor 231, the information receiver 240, a band pass filter 250b, an antenna 260, and a switch 270. Unlike FIG. 4, the terminal 200b according to the second exemplary embodiment of the present invention includes one band pass filter 250b and the switch 270.

The switch 270 is positioned between the band pass filter 250b and the distributor 231 and is positioned between the band pass filter 250b and the information receiver 240. That is, the information transmitter 210 and the power harvester 220 are connected to the antenna 260 through the switch 270 and the information receiver 240 is also connected to the antenna 260 through the switch 270.

When the terminal 200b is in the receiving mode (i.e., when the terminal 200b receives the information from the base station 100 through the downlink), S₁₁ is connected to S₁₂.

When the terminal 200b is in the transmitting mode (i.e., when the terminal 200b transmits the information to the base station 100 through the uplink), S₁₁ is connected to S₁₃. In this case, the transmitted signal output from the information transmitter 210 generates the self-interference signal (leakage signal), and the self-interference signal is input to the power harvester 220 through the distributor 231. The power harvester 220 converts the self-interference signal into the chargeable form to charge the battery.

Meanwhile, when the base station 100 is operated in the TDD, the base station 100 may not also transmit upon the transmission of the terminal 200b. Therefore, the energy amount harvested by the terminal 200b is as in the following Equation 2.

E_{M}≈ζ_{M}∥α_{M}x_{M}∥²T (Equation 2)

Further, when the base station 100 is operated in the full duplex scheme, the base station 100 may transmit the power signal through the downlink while the terminal 200b transmits the information through the uplink. The terminal 200b may use the power signal received from the base station 100 for power harvesting and therefore the energy amount harvested by the terminal 200b is as in the following Equation 3.

E_{M}=ζ_{M}∥δh_{D}x_{B}+α_{M}x_{M}∥²T (Equation 3)

When the terminal 200b is in an energy receiving mode (i.e., when the terminal 200b receives the energy from the base station 100), S11 is connected to S13 and the information transmitter 210 is turned off.

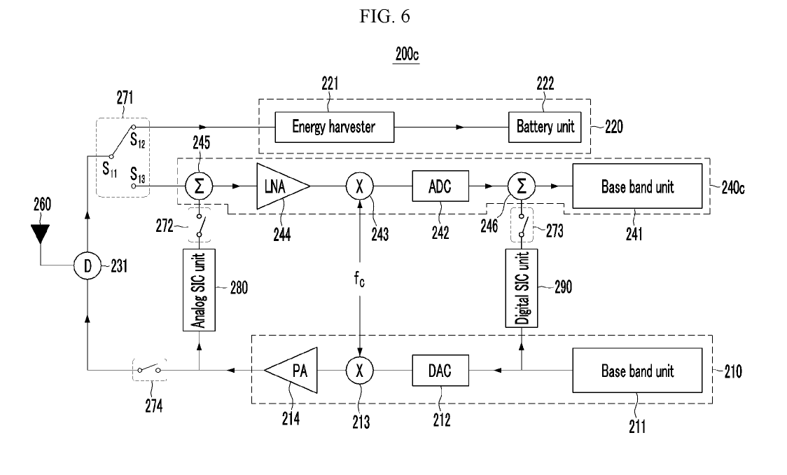

FIG. 6 is a diagram illustrating a terminal 200c according to a third exemplary embodiment of the present invention.

The terminal 200c according to the third exemplary embodiment of the present invention is operated in an in-band full duplex (IFD) scheme, and uses the self-interference (SI) signal generated in the in-band full duplex scheme to charge the battery.

As shown in FIG. 6, the terminal 200c according to the third exemplary embodiment of the present invention includes the information transmitter 210, the power harvester 220, the distributor 231, the information receiver 240c, the antenna 260, first to fourth switches 271 to 274, an analog SIC unit 280, and a digital SIC unit 290. Unlike FIG. 5, the terminal 200c according to the exemplary embodiment of the present invention includes the four switches 271 to 274, the analog SIC unit 280, and the digital SIC unit 290 to remove the self-interference signal. Further, the information receiver 240c further includes two signal mergers 245 and 246 to remove the self-interference signal.

The first switch 271 is positioned between the distributor 231 and the power harvester 220 (information receiver 240c). The second switch 272 is positioned between the analog SIC unit 280 and the signal merger 245, and the third switch 273 is positioned between the digital SIC unit 290 and the signal merger 246. Further, the fourth switch 274 is positioned between the distributor and the information transmitter 210.

The analog SIC unit 280 is positioned between a latter stage of a power amplifier 214 and a front stage of a low noise amplifier 244 and uses an analog circuit to remove the self-interference (SI) signal. The analog SIC unit 280 may be implemented as a finite impulse response (FIR) filter, etc., but the configuration and operation thereof may be appreciated by a person having ordinary skill in the art to which the present invention pertains and the detailed description thereof will be omitted.

The digital SIC unit 290 is positioned between a front stage of the digital-to-analog converter 212 and a latter stage of the analog-digital converter 242, and uses digital processing to remove the self-interference (SIC) signal. The detailed operation and operation of the digital SIC unit 290 may be appreciated by a person having ordinary skill in the art to which the present invention pertains and therefore the detailed description thereof will be omitted.

When the terminal 200c is operated in the in-band full duplex (IFD) scheme, the fourth switch 274 may always be closed or is omitted. In this case, when the terminal 200c is at a central portion of the cell, the terminal 200c is operated in the in-band full duplex (IFD) scheme, and when the terminal 200c is at an edge of the cell, the terminal 200c may be operated in a time division half duplex (TDD) scheme. When the terminal 200c is operated in the in-band full duplex (IFD) scheme, the self-interference removal (SIC) is required for information reception, and therefore the power harvesting may not be made using the self-interference (SI) signal. However, when the terminal 200c is operated in the time division half duplex (TDD) scheme, the power harvester 220 of the terminal 200c uses the leakage signal (i.e., the self-interference signal) of the information transmitter 210 input through the distributor 231 for power harvesting. Meanwhile, when the terminal 200c is operated in the in-band full duplex (IFD) scheme, the S₁₁ terminal of the first switch 271 is connected to S₁₃, and the second switch 272 and the third switch 273 are both closed.

Meanwhile, the terminal 200c according to the third exemplary embodiment of the present invention may receive the power from the base station 100 in the downlink while simultaneously transmitting the data information through the uplink. In this case, the S₁₁ terminal of the first switch 271 is connected to S₁₂, the second switch 272 and the third switch 273 are opened, and the fourth switch 274 is closed. In this case, the power harvester 220 of the terminal 200c uses the power signal transmitted from the base station 100 through the downlink and the leakage signal (i.e., self-interference signal) of the information transmitter 210 input through the distributor 231 for power harvesting.

When the terminal 200c is operated in the time division half duplex (TDD) scheme, the S₁₁ terminal of the first switch 271 is connected to S₁₂ or S₁₃ and the second switch 272 and the third switch 273 are opened. This operation is as follows. The information receiver 240c or the power harvester 220 is connected to the antenna 260 through the first switch 271. When the terminal 200c is in the information receiving mode (i.e., when receiving the information from the base station 100 in the downlink), the S₁₁ terminal of the first switch 271 is connected to the S₁₃ terminal and the fourth switch 274 is opened. When the terminal 200c is in the information transmitting mode (i.e., when transmitting the information to the base station 100 in the uplink), the S₁₁ terminal of the first switch 271 is connected to S₁₂ and the fourth switch 274 is also closed. In this case, the power harvester 220 of the terminal 200c uses the leakage signal (i.e., the self-interference signal) input through the distributor 231 for power harvesting. When the base station 100 is also operated in the time division half duplex (TDD) scheme, the base station 100 may not perform the transmission while the terminal 200c transmits information and therefore the energy amount harvested by the terminal 200c is as in the above Equation 2. However, when the base station 100 is operated in the in-band full duplex scheme, the base station 100 may also transmit the power signal while the terminal 200c transmits the information, and therefore the energy amount harvested by the terminal 200c is as in the above Equation 3.

The structure of the terminal 100c according to the third exemplary embodiment of the present invention may implement various transmission schemes by the manipulation of the switches and use the self-interference signal for power charging.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal comprising:
an information transmitter generating a first signal corresponding to an uplink signal transmitted to a base station; and
a power harvester receiving a self-interference signal generated by the first signal and charging power using the self-interference signal.

2. The terminal of claim 1, further comprising:
a first band pass filter passing through a band corresponding to the uplink signal;
a second band pass filter passing through a band corresponding to a downlink signal received from the base station;
a distributor transmitting the first signal to the first band pass filter and transmitting the self-interference signal to the power harvester; and
an information receiver decoding a signal passing through the second band pass filter.

3. The terminal of claim 1, further comprising:
an information receiver decoding a downlink signal received from the base station;
a distributor transmitting the first signal through an antenna and transmitting the self-interference signal to the power harvester; and
a switch switching between the antenna and the distributor or between the antenna and the information receiver.

4. The terminal of claim 3, wherein:
the terminal is operated in a time division half duplex scheme;
when the terminal is in a transmitting mode, the switch connects between the antenna and the distributor; and
when the terminal is in a receiving mode, the switch connects the antenna and the information receiver.

5. The terminal of claim 1, further comprising:
an information receiver decoding a downlink signal received from the base station;
a distributor transmitting the first signal through an antenna and transmitting the self-interference signal to the power harvester; and
a first switch switching between the distributor and the power harvester or between the distributor and the information receiver.

6. The terminal of claim 5, wherein:
when the terminal is operated in an in-band full duplex scheme, the first switch connects between the distributor and the information receiver; and
when the terminal is operated in a time division half duplex scheme and is in a transmitting mode, the first switch connects between the distributor and the power harvester and the self-interference signal is input to the power harvester through the distributor.

7. The terminal of claim 6, wherein
when the terminal is operated in the time division half duplex scheme and is in a receiving mode, the first switch connects between the distributor and the receiver.

8. The terminal of claim 6, wherein:
when the terminal is within a first distance from the base station, the terminal is operated in the in-band full duplex scheme; and
when the terminal is at a second distance farther than the first distance from the base station, the terminal is operated in the time division half duplex scheme.

9. The terminal of claim 1, wherein
the power harvester includes:
a battery unit storing power; and
an energy harvester converting the self-interference signal into a form chargeable in the battery unit and outputting the converted self-interference signal to the battery unit.

10. The terminal of claim 9, wherein
the energy harvester includes:
a diode rectifying the self-interference signal; and
a low pass filter passing through only a low frequency signal in a diode output.

11. The terminal of claim 1, wherein
the power harvester charges power using a power signal transmitted from the base station.

12. A method for charging power by a terminal transmitting an uplink signal to a base station and receiving a downlink signal from the base station, comprising:
generating a first signal corresponding to the uplink signal;
extracting a self-interference signal from the first signal; and
charging power using the self-interference signal.

13. The method of claim 12, further comprising:
determining whether the terminal is within a predetermined distance from the base station,
wherein when the terminal is within the predetermined distance, the terminal is operated in an in-band full duplex scheme; and
when the terminal is not within the predetermined distance, the terminal is operated in a time division half duplex scheme.

14. A terminal comprising:
an information transmitter generating a first signal corresponding to an uplink signal transmitted to a base station;
an information receiver decoding a downlink signal received from the base station;
a power harvester charging power using a self-interference signal generated by the first signal; and
a switch switching between the antenna and the power harvester or between the antenna and the information receiver depending on a mode.

15. The terminal of claim 14, wherein
the mode includes a transmitting mode and a receiving mode, and
when the terminal is operated in a time division half duplex scheme and is in a transmitting mode, the first switch connects between the antenna and the power harvester and the self-interference signal is input to the power harvester.

16. The terminal of claim 14, further comprising
a distributor positioned between the antenna and the switch and positioned between the antenna and the information transmitter,
wherein the self-interference signal is input to the power harvester through the distributor and the switch.

17. The terminal of claim 14, wherein:
when the terminal is within a first distance from the base station, the terminal is operated in the in-band full duplex scheme; and
when the terminal is at a second distance farther than the first distance from the base station, the terminal is operated in the time division half duplex scheme.
